(19) United States
(12) Patent Application Publication
(10) Pub. No.: US 2015/0058077 A1
(43) Pub. Date: Feb. 26, 2015

(54) REPORTING RESULTS OF AN AB TYPE OF TEST

(71) Applicant: KOBO Incorporated, Toronto (CA)

(72) Inventors: Marie BUBAN, Toronto (CA); Talia BORODIN, Toronto (CA); Jordan CHRISTENSEN, Toronto (CA); Sylvain MEILOT, Toronto (CA)

(73) Assignee: KOBO Incorporated, Toronto (CA)

(21) Appl. No.: 13/975,165

(22) Filed: Aug. 23, 2013

(51) Int. Cl. G06Q 30/02

(52) U.S. Cl. CPC G06Q 30/0202
USPC 705/7.31

(57) ABSTRACT

A first subset of results, from testing a first version of an item versus a second version of the item, is accessed and displayed. The first subset includes first values associated with the first version and second values associated with the second version. The first subset is determined according to settings for parameters associated with the data. A representation of the first values includes a first band having a first width corresponding to confidence intervals for the first values, and a representation of the second values includes a second band having a second width corresponding to confidence intervals for the second values. In response to a change in the settings, a second subset of the results is automatically determined, accessed, and displayed and the first width and the second width of the first and second bands are automatically updated and displayed.

### BACKGROUND

A randomized comparative (or controlled) experiment (or trial), commonly referred to as an AB (or NB) test, provides a relatively straight-forward way of testing a change to the current design of an item, to determine whether the change has a positive effect or a negative effect on some metric of interest. In a typical AB test, data is collected for a first design (a first version of an item to be tested) and for a second design (a second version of the item), where the first and second versions are identical in virtually all respects except for the change being tested.

For example, an AB test can be used to test a change to a Web page before the change is implemented on a more permanent basis, to determine whether the change has a positive or negative effect on, for example, metrics for purchases, account activations, downloads, and whatever else might be of interest. For instance, the color of the “buy” button in one version of the Web page (the current version) may be different from that in another version of the Web page (the changed version), in which case the AB test is designed to test the effect of the button's color on some metric, such as the number of visits that result in a purchase.

While the AB test is being performed, some participants will use the first (current) version of the item being tested while the remaining participants will use the second (changed) version. “Allocation” refers to the percentage of participants that will use the second (changed) version. In a typical AB test, the allocation is 50 percent, meaning half of the participants will use the second version, with the other half using the first version.

During the AB test, data is collected and analyzed to determine the change in a metric of interest associated with the change in the item being tested—the difference (positive or negative) in the value of the metric of interest (e.g., uses that result in purchases) using the first version versus the value for that metric using the second version.

The AB test is preferably planned and executed with statistical rigor to avoid any tendency to pick and choose results that favor one version over the other. There may be a natural variance in the results over time due to factors other than the change itself. For example, results may vary according to the day of the week. Without statistical rigor, a test administrator might arbitrarily stop the testing once the results appear to favor one version over the other, without considering whether the results would trend the other way if the testing continued. Ideally, the AB test is scheduled to last long enough to get a sample size that is large enough to be statistically significant.

### SUMMARY

Conventional products are available for administering AB tests and for viewing test results in real time. However, a problem with those products is that, when viewing the test results, it is not apparent whether the sample size is adequate and/or whether the results are statistically significant. Without ready access to such information, a test administrator may incorrectly decide that one version of the item being tested is better than another.

In overview, embodiments according to the present invention address this problem by including confidence bands in the displays of test results. The dimensions (e.g., widths) of the confidence bands correspond to the confidence intervals (e.g., 95 percent) associated with the results. Space between the confidence bands indicates the test results are statistically significant (e.g., at 95 percent confidence). The dimensions of the confidence bands are automatically adjusted to reflect the variance in the results and sample size over time (e.g., as the test proceeds and more data is collected), so that users can readily determine whether or not the test has been run long enough to accumulate an adequate sample size. Also, the test data can be filtered to allow more granular analysis. If the data is filtered and the sample size is thus reduced, then the dimensions of the confidence bands are automatically adjusted in response, so that users can readily determine whether or not the filtered data includes enough data for the test results to be statistically valid.

Generally speaking, a user (e.g., test administrator) can readily interact with the test data. Test results, including graphs of a metric or metrics of interest versus time and associated confidence bands for each version of the item being tested, are displayed in an easy-to-read format. Various menus can be displayed alongside the test results, so that the user can readily change settings and filter the data. As the data is filtered, the display—in particular, a graph of a metric of interest versus time, and the dimensions of the confidence bands—is automatically updated.

In one embodiment, a first subset of the test results is accessed/determined. The first subset includes first values (e.g., values for a metric of interest) associated with a first version of an item being tested, and also includes second values (e.g., values for the metric of interest) associated with a second version of the item. The first subset is determined (calculated) according to settings for parameters associated with the test data. A representation of the first values and a representation of the second values are displayed in the same view (e.g., in a single graph). The representation of the first values includes a first band having a first width corresponding to confidence intervals for the first values, and the representation of the second values includes a second band having a second width corresponding to confidence intervals for the second values. In response to a change in the settings, a second subset of the results is automatically determined, accessed, and displayed, and the first width and the second width of the first and second bands are automatically updated in the display.

As mentioned, the test data can be filtered. To do this, a user specifies settings to select and display metrics for a subset of the data of interest to the user. A graphical user interface that allows the user to change settings can be displayed in the same view as the displayed metrics. The settings can include a setting that specifies a rolling window of time (including cumulative to date). In one embodiment, the item being tested is an e-commerce Web site, in which case the settings can include a setting that specifies a step in a conversion funnel and the metrics can include e-commerce conversion rates. The settings can also include, but are not limited to, settings that specify a geographic location of a user, a language (e.g., English), a type of Web browser, a type of device (e.g., a smartphone versus a personal computer), and a type (category) of user (e.g., new customer versus returning customer).

The test results (metrics) can be displayed in different ways, depending on settings selected by a user. For example, for a Web-based test in which visitors access different versions of a Web site, metrics can be displayed based on the geographic locations of the visitors, percentage of users that complete each of the steps in a conversion funnel, activities performed by the visitors (e.g., a search is performed), number of units purchased by visitors, types of devices used by visitors, and/or types of Web browsers used by visitors.

In summary, embodiments according to the present invention allow test administrators to more readily determine whether test results (e.g., values for a metric or metrics of interest) are statistically valid as a whole as well as for various subsets of data, allowing the test administrators to make better informed and more accurate decisions when evaluating different versions of an item being tested. Test results can be analyzed with more granularity; administrators can drill down into the test data in different ways by selecting different subsets of the data. Metrics based on the various subsets of data are displayed along with their respective confidence bands, so that administrators can readily identify whether or not a subset has sufficient sample size to detect a statistically significant result. Generally speaking, test results can be viewed in different ways while maintaining statistical rigor.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an example of a computing system capable of implementing embodiments according to the present disclosure.

FIG. 2 is a flowchart that provides an overview of an AB test process in an embodiment according to the present invention.

FIG. 3 is a block diagram illustrating an example of an AB test in operation in an embodiment according to the present invention.

FIGS. 4, 5, 6, 7, 8A, 8B, 9, 10, 11, 12, and 13 are examples of displays that that can be used to present test results in embodiments according to the present invention.

FIG. 14 is a flowchart of an example of a computer-implemented method for presenting test results in an embodiment according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

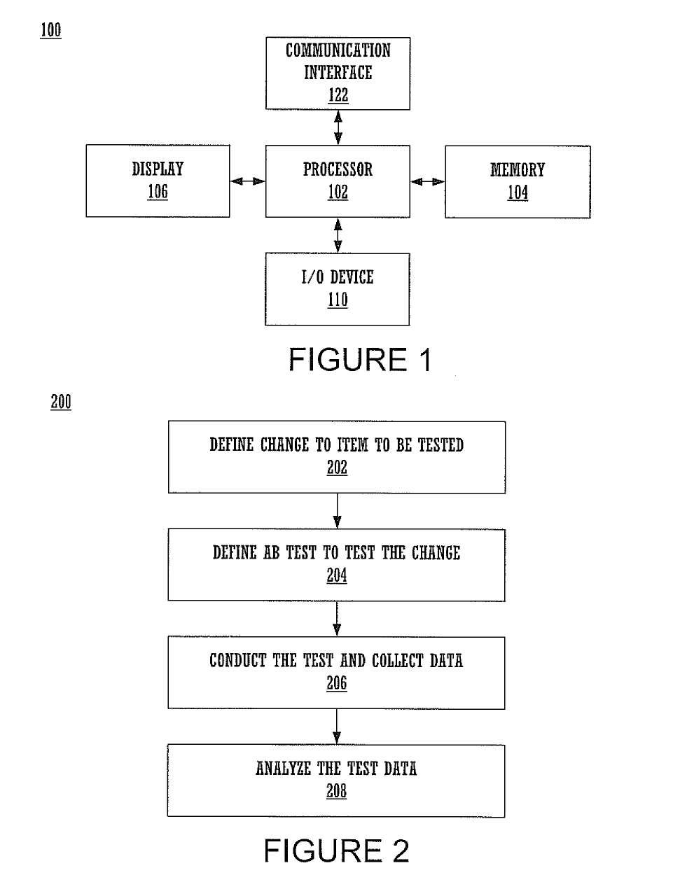

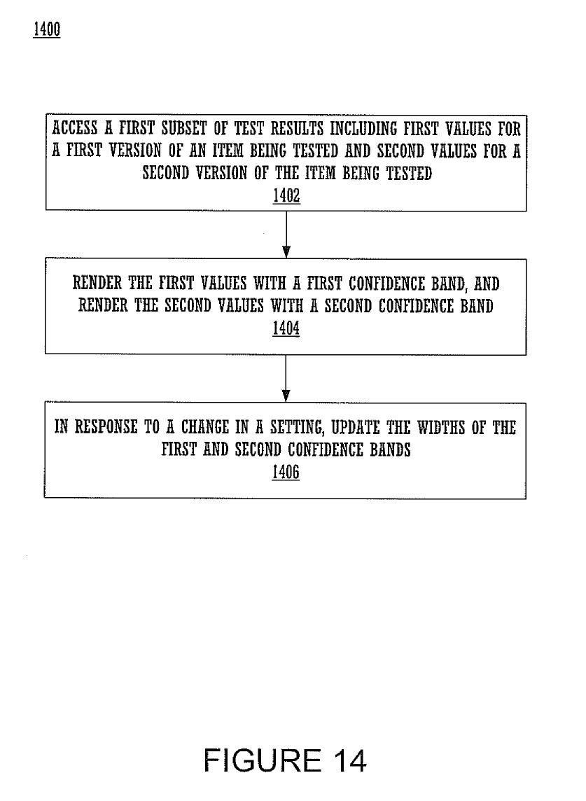

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “displaying,” “rendering,” “receiving,” “determining,” “updating,” “selecting,” “filtering,” “segmenting,” or the like, refer to actions and processes (e.g., the flowchart 1400 of FIG. 14) of a computer system or similar electronic computing device or processor (e.g., the computing system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computing system or computing device 100 capable of implementing embodiments according to the present invention. The computing system 100 broadly represents any single or multi-processor computing device or system capable of executing computer-readable instructions. Examples of a computing system 100 include, without limitation, a desktop, laptop, tablet, or handheld computer. Depending on the implementation, the computing system 100 may not include all of the elements shown in FIG. 1, and/or it may include elements in addition to those shown in FIG. 1.

In its most basic configuration, the computing system 100 may include at least one processor 102 and at least one memory 104. The processor 102 generally represents any type or form of processing unit capable of processing data or interpreting and executing instructions. In certain embodiments, the processor 102 may receive instructions from a software application or module. These instructions may cause the processor 102 to perform the functions of one or more of the example embodiments described and/or illustrated herein.

The memory 104 generally represents any type or form of volatile or non-volatile storage device or medium capable of storing data and/or other computer-readable instructions. In certain embodiments, the computing system 100 may include both a volatile memory unit (such as, for example, the memory 104) and a non-volatile storage device (not shown).

The computing system 100 also includes a display device 106 that is operatively coupled to the processor 102. The display device 106 is generally configured to display a graphical user interface (GUI) that provides an easy to use interface between a user and the computing system.

As illustrated in FIG. 1, the computing system 100 may also include at least one input/output (I/O) device 110. The I/O device 110 generally represents any type or form of input device capable of providing/receiving input or output, either computer- or human-generated, to/from the computing system 100. Examples of an I/O device 110 include, without limitation, a keyboard, a pointing or cursor control device (e.g., a mouse), a speech recognition device, or any other input device. The I/O device 110 may also be implemented as a touchscreen that may be integrated with the display device 106.

The communication interface 122 of FIG. 1 broadly represents any type or form of communication device or adapter capable of facilitating communication between the example computing system 100 and one or more additional devices. For example, the communication interface 122 may facilitate communication between the computing system 100 and a private or public network including additional computing systems. Examples of a communication interface 122 include, without limitation, a wired network interface (such as a network interface card), a wireless network interface (such as a wireless network interface card), a modem, and any other suitable interface. In one embodiment, the communication interface 122 provides a direct connection to a remote server via a direct link to a network, such as the Internet. The communication interface 122 may also indirectly provide such a connection through any other suitable connection. The communication interface 122 may also represent a host adapter configured to facilitate communication between the computing system 100 and one or more additional network or storage devices via an external bus or communications channel.

Many other devices or subsystems may be connected to computing system 100. Conversely, all of the components and devices illustrated in FIG. 1 need not be present to practice the embodiments described herein. The devices and subsystems referenced above may also be interconnected in different ways from that shown in FIG. 1. The computing system 100 may also employ any number of software, firmware, and/or hardware configurations. For example, the example embodiments disclosed herein may be encoded as a computer program (also referred to as computer software, software applications, instructions, or computer control logic) on a computer-readable medium.

The computer-readable medium containing the computer program may be loaded into the computing system 100. All or a portion of the computer program stored on the computer-readable medium may then be stored in the memory 104. When executed by the processor 102, instructions loaded into the computing system 100 may cause the processor 102 to perform and/or be a means for performing the operations of the example embodiments described and/or illustrated herein. Additionally or alternatively, the example embodiments described and/or illustrated herein may be implemented in firmware and/or hardware.

In general, in embodiments according to the present invention, the operations performed by the computing system 100 are useful for generating a graphical user interface (GUI) for reporting and analyzing results of an AB test. In one embodiment, the GUI includes a first representation of a first group of values associated with a first version of an item being tested with the AB test. The first representation includes a first band having a first width corresponding to confidence intervals for the first group of values, and also includes a first line within the first band that depicts the first group of values versus time. In such an embodiment, the GUI also includes a second representation of a second group of values associated with a second version of the item being tested. The second representation includes a second band having a second width corresponding to confidence intervals for the second group of values, and also includes a second line within the second band that depicts the second group of values versus time. In one embodiment, the GUI also includes GUI elements representing parameters associated with the test results; the first group of values and the second group of values represent a first subset of the results determined (calculated) and accessed according to settings for the parameters. In response to a change in the settings, a second subset of the results is determined, accessed, and displayed, and the first width and the second width of the first band and the second band, respectively, are automatically updated and displayed.

FIG. 2 is a flowchart 200 that provides an overview of an AB test process in an embodiment according to the present invention. In block 202, a potential change to an item to be tested is identified. For example, a client (e.g., a business owner) or Web page designer can identify a potential change to a Web page. However, embodiments according to the invention are not limited to testing changes to Web pages. Other examples of changes that can be tested include, but are not limited to, changes to: hardware features (e.g., features of devices); software features (e.g., features of applications); document or message (e.g., email) content; and document or message (e.g., email) format.

In block 204, a test (e.g., an AB test) is planned, in order to test the change. More specifically, a test that will measure the impact of the change on a metric or metrics of interest is planned.

The test may include a ramp-up period that allows the test to be ramped up in a safe (more conservative) way. For example, instead of establishing a 50 percent allocation from the beginning of the test, an allocation of 25 percent may be specified during the ramp-up period. The ramp-up period can be used to detect whether there is a substantial issue with the change (e.g., a bug) before the allocation is increased to 50 percent. In this manner, a change that has a relatively large negative effect can be evaluated and identified early while reducing the impact of the change on the cost of the test (e.g., lost sales).

Stop criteria are also defined for the test, based on tradeoffs between the length and cost of the test versus the amount (e.g., percentage) of change in the metric of interest that the test planner would like to detect.

In block 206, the test is conducted and data is collected. The test is ended when the stop criteria are reached.

In block 208, the test data is analyzed, so that a decision can be made as to whether or not the change to the item being tested should be implemented.

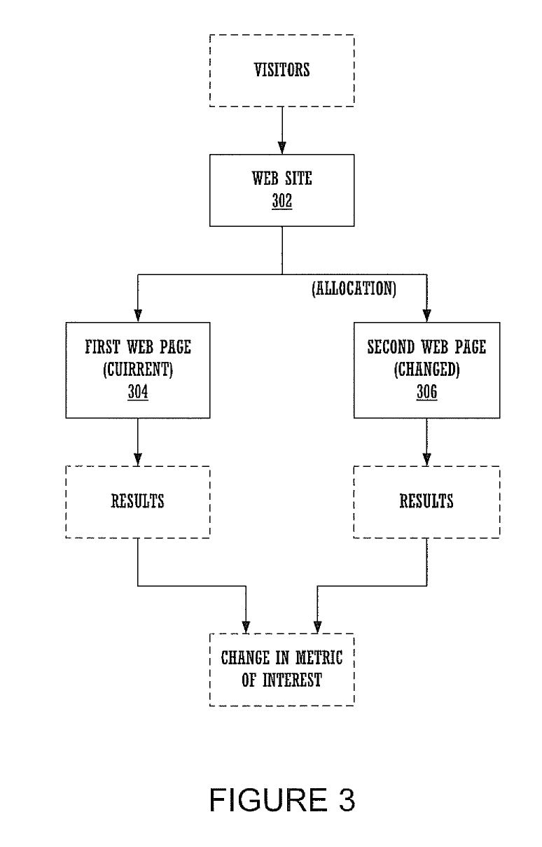

FIG. 3 is a block diagram illustrating an example of an AB test in operation in an embodiment according to the present invention. The example of FIG. 3 pertains to a test of a change to a Web page; however, embodiments according to the present invention are not limited to Web pages, as mentioned above.

In the example of FIG. 3, visitors access a Web site 302 in a conventional manner (e.g., by entering a Uniform Resource Locator (URL) address). The AB test is typically conducted so that it is transparent to the visitors. That is, visitors to the Web site 302 are randomly selected so that they are shown either a first Web page 304 or a second Web page 306. While random, the process is controlled so that the number of visitors shown the second Web page 306 corresponds to the allocation specified by the test planner. That is, if an allocation of 50 percent is specified, then a random selection of 50 percent of the visitors will be shown the second Web page 306. As noted above, the allocation can change over time (e.g., there may be a ramp-up period). Once shown the new variant, users will typically continue to see the new variant through the course of the test. This is to avoid unsavory effects of bouncing users back and forth between different variants. Over time this can mean an overall allocation different than the original test design but which is easily accounted for.

Results for each of the Web pages 304 and 306 are collected and analyzed to determine the amount of change to a metric or metrics of interest, often referred to as Overall Evaluation Criteria (OEC). The OEC may be expressed in terms of a binary conversion rate. For example, for an e-commerce Web site, a metric of interest may be expressed as “buy” versus “did not buy” or “activate” versus “did not activate.” However, the testing is not limited to binary tests, also referred to as Bernoulli trials. The metric(s) of interest can instead be expressed in non-binary terms such as total purchase amounts (e.g., in dollars).

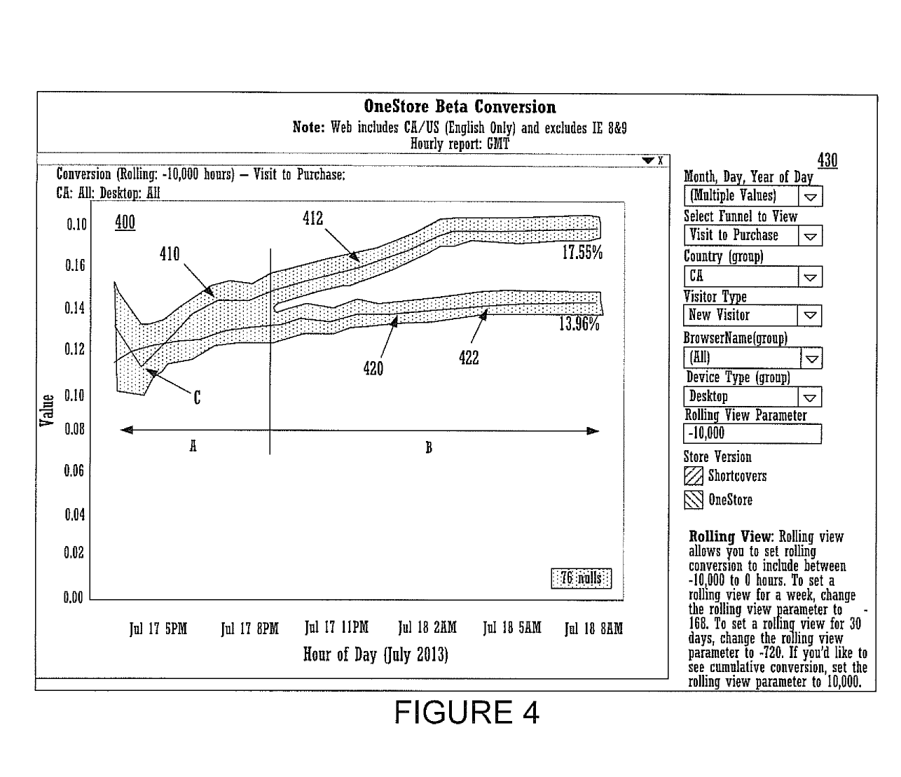

FIG. 4 is an example of a display 400 that can be used to present test results in an embodiment according to the present invention. In the example of FIG. 4, the test results are for an AB test of an e-commerce Web site (e.g., the item being tested is a Web page). In the example of FIG. 4, the test results presented in the display 400 include conversion rates for different versions of an e-commerce Web site. Specifically, the conversion rate in this example measures the percentage of site visits that result in purchase. However, as noted above, embodiments according to the invention are not limited to testing of Web sites and Web pages.

In FIG. 4, the display 400 includes a first line 410 that depicts test results versus time for a first variant being tested. The first variant is commonly referred to as group A, representing the control group (tests need not measure control versus target; however, that is the most common usage in AB testing where A typically refers to control and B for beta or variant being tested). The display 400 also includes a second line 420 that depicts test results versus time for a second variant, where the second variant is different from the first.

Significantly, the display 400 also includes a first confidence band 412 and a second confidence band 422. The confidence band 412 is displayed around the first line 410, and represents the confidence interval (in this embodiment, 95 percent confidence interval; however, any confidence measure can be used) versus time of the performance metric of the first variant. The confidence band 422 is displayed around the second line 420, and represents the confidence interval versus time of the performance metric of the second variant. The dimensions (e.g., width) of the confidence bands 412 and 422 correspond to the magnitude of the respective confidence intervals. The confidence intervals represented by the confidence band 412 are calculated using the data represented by the first line 410, and the confidence intervals represented by the confidence band 422 are calculated using the data represented by the second line 420. The confidence intervals are calculated for a specified confidence level (e.g., 95 percent).

In the FIG. 4 embodiment, space between the two confidence bands 412 and 422 indicates the test results are statistically significant. Thus, the test results are not statistically significant in the time period identified as region A of FIG. 4 but are statistically significant in the time period identified as region B. This is true because the separation between confidence intervals implies there is no overlap in values likely to occur by chance. In this manner, a user can readily determine whether or not the test results are statistically significant (this condition is sufficient but not necessary). Statistically significance of the net change is less conservative. Non-overlapping confidence bands imply statistical significance while overlapping confidence bands could be significant. The difference between two measures is close and since the former is always correct and easily to visually observe it is used. Also note that, at point C of FIG. 4, the line 410 falls below the line 420 indicating, at that point in time, that the second version (the variant) is outperforming the control in terms of the metric of interest (conversion rate). If a conclusion was to be drawn at that point in time, it would have been incorrect, as ultimately the test results show the control outperforming the variant. However, in embodiments according to the invention, the confidence bands 412 and 422 readily indicate that the test results at point C are not yet statistically significant, thereby making it apparent to a test administrator that any conclusion at that point would be premature at best.

In one embodiment, a set of parameters 430 is also displayed within the same view as the test results (the lines 410 and 420) and confidence bands 412 and 422. In the example of FIG. 4, the parameters 430 are implemented as drop-down menus. A user (e.g., test administrator) can readily specify and subsequently change the values of any of the settings. The parameters 430 may include, but are not limited to: date range, conversion funnel type, country, visitor type, browser name, and device type.

In the example of FIG. 4, the display 400 represents test results determined from a subset of the cumulative test data (accumulated from the beginning of the AB test), where the subset is selected according to the specified settings for the parameters 430. In the example of FIG. 4, the selected conversion funnel step is “Visit to Purchase,” the selected country is “CA” (Canada), and the selected device type is “desktop.” Accordingly, a subset of the test data corresponding to the specified settings is selected and used as the basis for calculating values for a metric of interest (e.g., conversion rate versus time) depicted by the first line 410 and the second line 420 and also for calculating the confidence bands 412 and 422, where the lines 410 and 412 and their respective confidence bands now reflect the subset of data selected by the parameters.

If one or more of the parameters 430 are changed, then the test results included in the display 400 are automatically updated. More specifically, if a setting or settings is changed, then a new (second) subset of the test data corresponding to the new settings is selected, and the second subset is used as the basis for calculating new values of the metric of interest (e.g., conversion rate versus time) and new values for the confidence intervals/confidence bands.

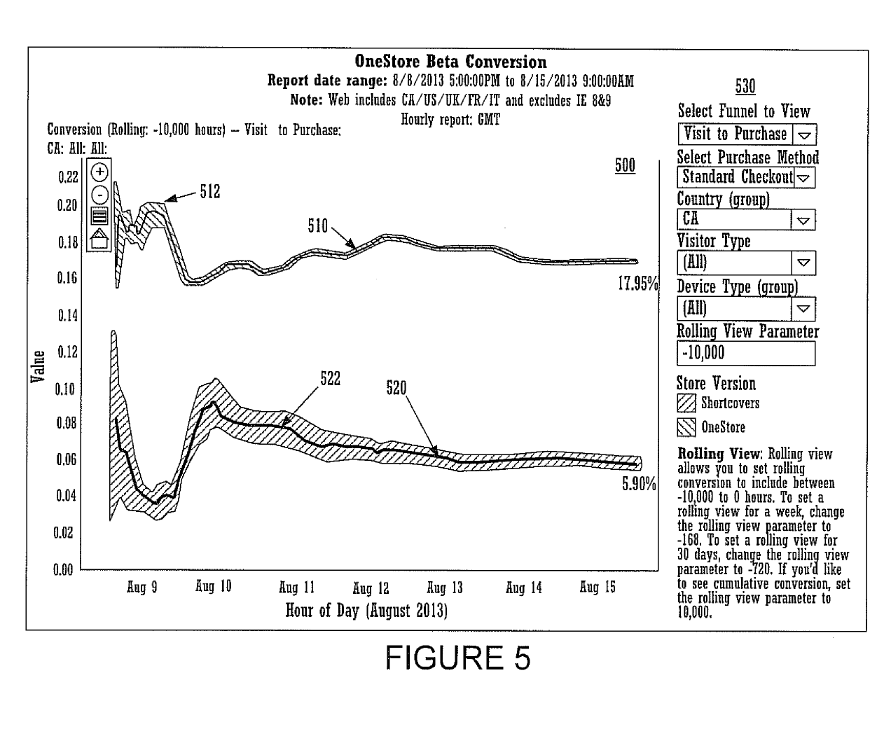

Thus, a user can specify different settings for the parameters 430 in order to drill down to smaller and smaller segments of the test data. This can allow for fine-grain analysis of the data, to identify where the test is under- and over-performing, for example. Because the confidence bands automatically adjust in response to a change in settings, a user can readily visualize how far he/she can drill down and still achieve statistically significant results. Thus, embodiments according to the invention can eliminate errors that can occur when users drill down to samples sizes that are insufficient for statistical rigor. This concept is further described and illustrated in conjunction with FIGS. 5, 6, and 7.

FIG. 5 is an example of a display 500 that can be used to present test results in an embodiment according to the present invention. In the example of FIG. 5, the display 500 represents conversion rates for different versions of an e-commerce Web site (Web page). Specifically, the conversion rates in this example measure the percentage of site visits that result in purchase. The first line 510 and the first confidence band 512 are associated with a first version of the Web site, and the second line 520 and the second confidence band 522 are associated with a second version of the Web site. The conversion rate values (lines 510 and 520) and corresponding confidence bands 512 and 522 that are presented in the display 500 are based on a first subset of the test data. The first subset is determined based on the settings for the parameters 530 also included in the display 500. The confidence band 522 is wider than that the confidence band 512; in this instance, the variant corresponding to the line 510 contains more than 50 percent allocation, which means the total sample size is larger than the total sample size of the variant corresponding to the line 520, allowing the range of values that could occur at random to be narrowed.

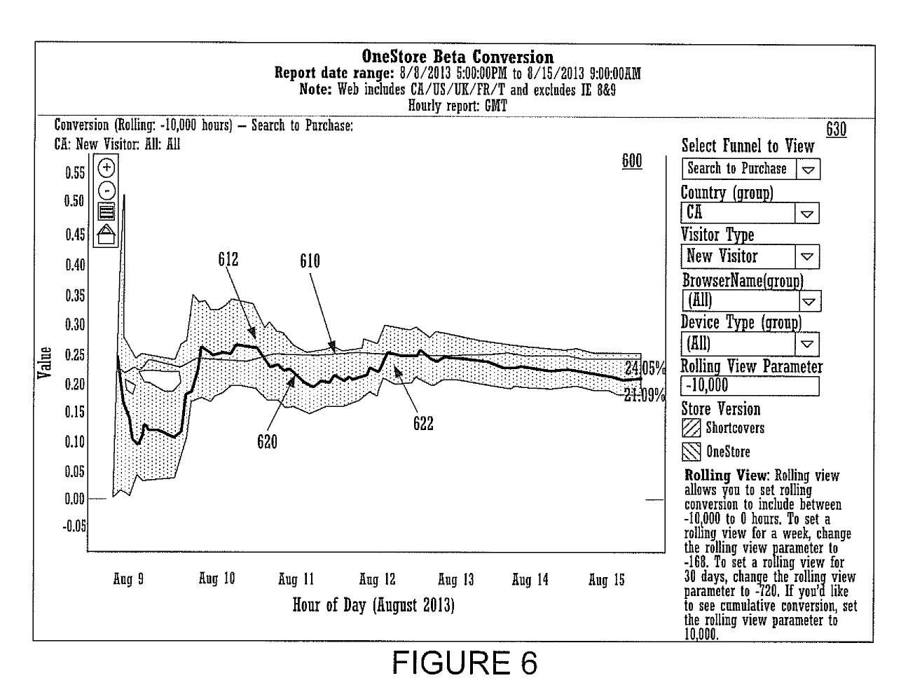

FIG. 6 is an example of a display 600 that can be used to present test results in an embodiment according to the present invention. In the example of FIG. 6, the display 600 represents conversion rates for different versions of the e-commerce Web site (Web page) associated with the test results of FIG. 5. The first line 610 and the first confidence band 612 are associated with the first version of the Web site, and the second line 620 and the second confidence band 622 are associated with the second version of the Web site.

In contrast to FIG. 5, the conversion rates illustrated in FIG. 6 measure the percentage of searches that result in purchase. Other settings for the parameters 630 are the same as the settings of FIG. 5. In FIG. 6, the conversion rate values (lines 610 and 620) and corresponding confidence bands 612 and 622 that are presented in the display 600 are based on a second subset of the test data. The second subset is determined based on the settings for the parameters 630. The ability to view results by different types of conversion (e.g., Web site visitors that conduct a search before purchasing) allows test administrators to better understand what is driving the behavior of the visitors, which might not otherwise be apparent. The results presented in FIG. 6 infer that the conversion rate for the control and the conversion rate for the variant are statistically tied. In this case, the variant represented by the line 620 contains much fewer records and thus has more variability in the values that could occur at random. In this case, the visualization is being dominated by the confidence band 622, which is large and overlaps the line 610.

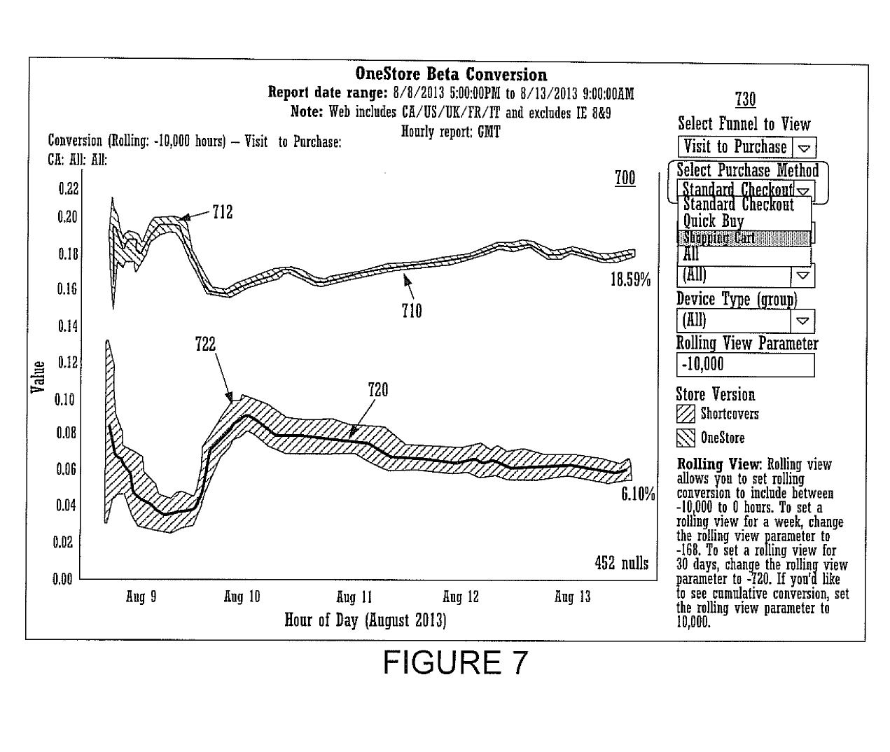

FIG. 7 is an example of a display 700 that can be used to present test results in an embodiment according to the present invention. In the example of FIG. 7, the display 700 represents conversion rates for different versions of the e-commerce Web site (Web page) associated with the test results of FIG. 5. The first line 710 and the first confidence band 712 are associated with the first version of the Web site, and the second line 720 and the second confidence band 722 are associated with the second version of the Web site.

In the example of FIG. 7, the settings 730 specify a purchase method (e.g., via a site's Shopping Cart), in contrast to FIG. 5, which did not filter test data using such a setting. By filtering test data based on purchase method, a better understanding of purchase behavior, and changes in purchase behavior that may occur as a result of offering different purchase methods, can be obtained. Other settings for the parameters 730 are the same as the settings of FIG. 5. In FIG. 7, the conversion rate values (lines 710 and 720) and corresponding confidence bands 712 and 722 that are presented in the display 700 are based on a third subset of the test data. The third subset is determined based on the settings for the parameters 730.

Thus, as illustrated by the examples of FIGS. 5, 6, and 7, it is possible to segment (filter) test data and view test results determined from the filtered data, to provide more granular analysis of test data and results. Test administrators can drill down into the data in different ways by specifying different settings in order to select different subsets of the data. Results (e.g., metrics) determined using the various subsets of data are displayed along with their respective confidence bands, so that administrators can readily identify whether or not a subset is statistically significant. Generally speaking, as demonstrated by the examples of FIGS. 5, 6, and 7, test results can be viewed in different ways while maintaining statistical rigor.

With reference back to FIG. 4, in one embodiment, the parameters 430 include a rolling view parameter 435. The rolling view parameter allows a user to specify a rolling window of time, such as a 24-hour window. If a 24-hour window is specified, for example, a conversion rate is calculated using test data accumulated over the previous 24-hour period. If, for example, the conversion rate is calculated each hour, then the conversion rate calculated at hour H includes only the test data for the 24-hour period including and preceding hour H, the conversion rate calculated at hour H+1 includes only the test data for the 24-hour period including and preceding hour H+1, and so on.

As the rolling view parameter is shortened to include less data, the overall sample size, or N-size as it is commonly called, decreases, which in turn causes the confidence intervals to increase. In embodiments according to the present invention, if the confidence intervals change (e.g., increase), then the confidence bands (e.g., the bands 412 and 422) will also change (e.g., widen).

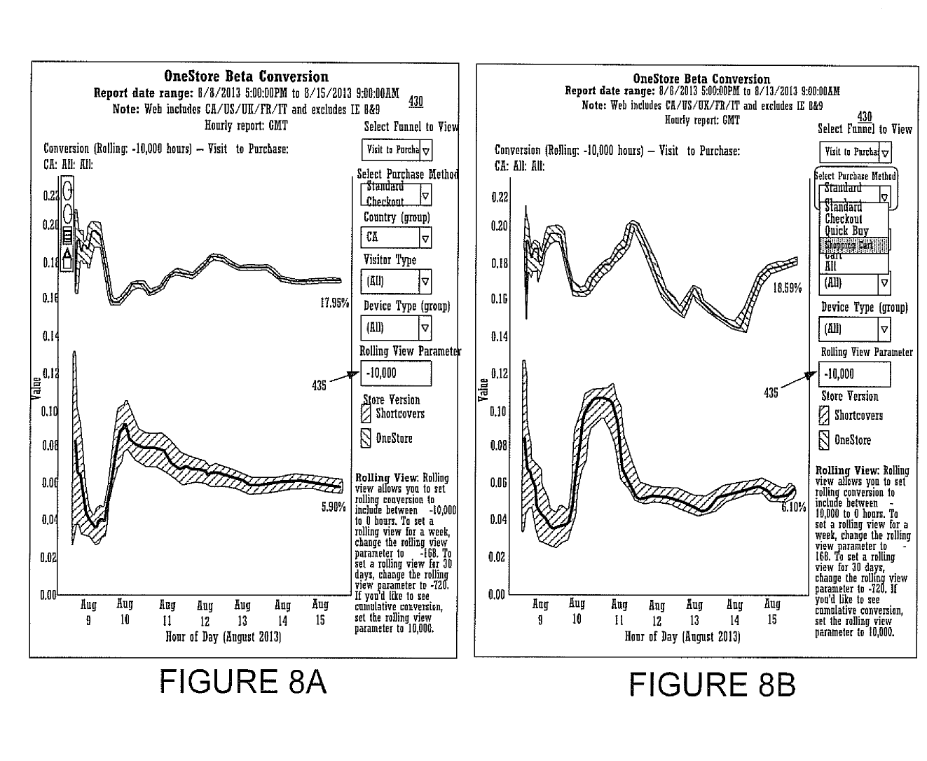

FIG. 8A illustrates conversion rate versus time when the rolling view parameter 435 is set to a value that extends back to the beginning of the AB test (e.g., a value of −10,000 hours). As a result, all of the accumulated test data (but filtered according to the settings for the other parameters 430) is included in the subset of data used to determine conversion rate versus time. In FIG. 8B, the rolling view parameter 435 is set to −24 hours so that the subset of data used to determine conversion rate versus time is based only on the rolling 24-hours' worth of data, as described above.

Changing the value of the rolling view parameter 435 allows a user to view a metric of interest (e.g., conversion rate) at different levels of the test data (cumulative, daily, weekly, monthly, etc.), which allows for added flexibility in detecting and understanding seasonal effects while maximizing the available sample size. The rolling view parameter allows the user to look for seasonal trends by varying the range of the rolling average. As mentioned above, the displayed confidence bands will automatically adjust when a setting such as the value for the rolling view parameter 435 is changed, and thus the user can readily determine whether the selected setting filters the test data in a way that is statistically valid.

Similarly, when looking for seasonal trends or event-driven differences in a metric of interest (e.g., conversion rate), it can be desirable to look at the smallest date range possible to achieve statistical significance. For example, if testing a product while an event such as a holiday or short-lived sale is occurring, it might be desirable to look at just the period affected by the event; however, this period may not provide enough data to be statistically meaningful. The rolling view parameter 435 allows the user to specify a relatively small range and then increase it as needed to get a large enough sample size to make meaningful inferences.

This functionality is particularly useful when AB test specifications are adjustable. For example, suppose the allocation for an AB test is initially set at 25 percent during a ramp-up period (that is, 25 percent of test participants will be directed to use the variant and the remaining 75 percent will be directed to use the control during the ramp-up period). After verifying that the test is proceeding satisfactorily, the allocation can be increased to, for example, 50 percent. Consequently, data gathered after the allocation is increased is worth twice as much for the first group (the group going from 25 percent to 50 percent) and similarly half as much for the other (second) group. Looking at a cumulative view with this type of change will make the recent data trends much more meaningful in the first group then the second group. Embodiments according to the invention permit analysis that accounts for this type of effect. For example, a user can change the setting for a date filter so that only test results for dates after the allocation is changed are displayed. As noted previously herein, the displayed values for the metric of interest (e.g., conversion rate) and the displayed confidence bands will adjust to reflect the drop in sample size. Alternatively, a user can specify a rolling average range that will display results since the change in allocation. In this embodiment, two colors are used to specify significantly significant results—one color for positive increases and another color for accurate. Results that are statistically tied are in one color to represent the fact that even though one result may appear higher than the other; from a statistical point of view there is no real difference.

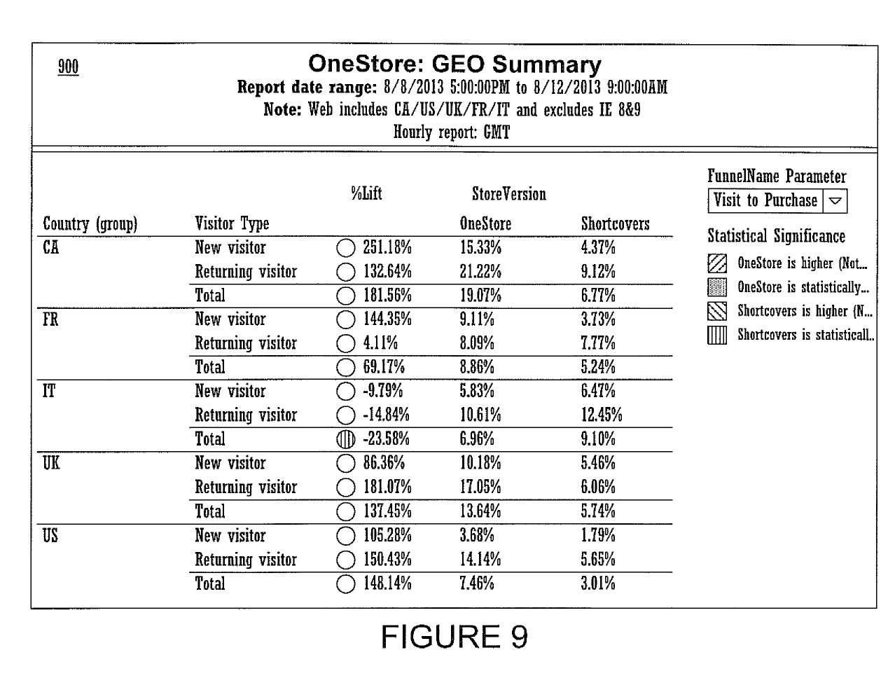

FIG. 9 illustrates an example of a display 900 of test results including percentage lift (percent change in the metric of interest) in an embodiment according to the present invention. In this example, the results are sorted by country. In this example, the conversion rate is given for two different versions of the item being tested. The percentage lift denotes the percentage change (plus or minus) in the conversion rate for one version versus the conversion rate for the other version. Different colors can be used to indicate whether the percentage lift is statistically significant or not. In other words, one color can be used to indicate a value for percentage lift that is statistically significant, while a different color can be used to indicate a value for percentage lift that is not statistically significant. The information presented in the display 900 can also be filtered by changing the settings of parameters using drop-down menus or the like included in the display 900.

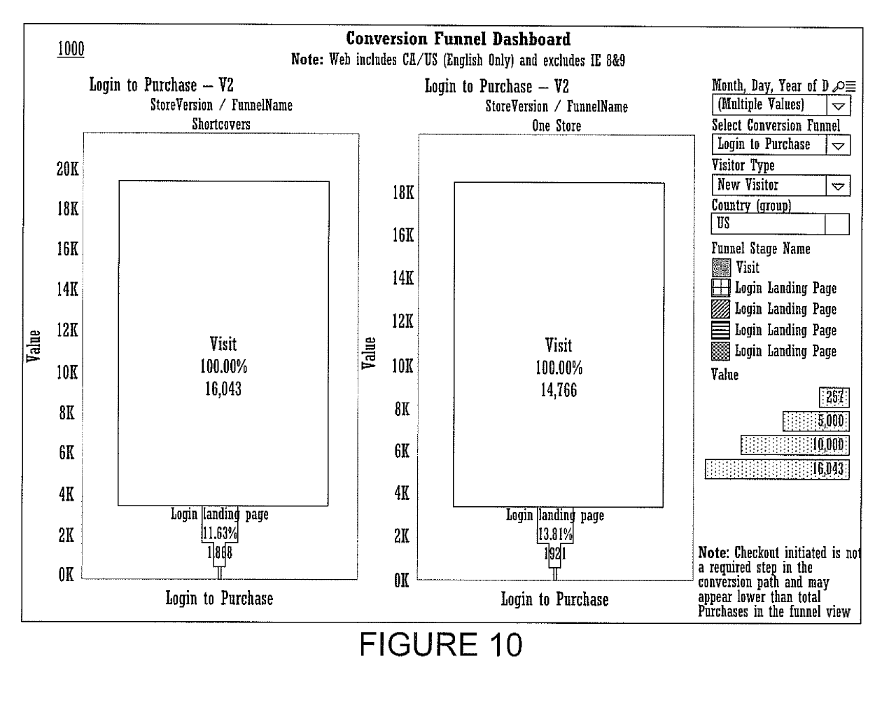

FIG. 10 illustrates an example of a display 1000 showing a step-by-step funnel view of a conversion path in an embodiment according to the present invention. The information presented in the display 1000 can help a test administrator identify where visitors to a Web site may be dropping off during an expected purchase path. The metrics show the percentage of visitors who continue on to the next step in the conversion path. The information presented in the display 1000 can also be filtered by changing the settings of parameters using drop-down menus or the like included in the display 1000.

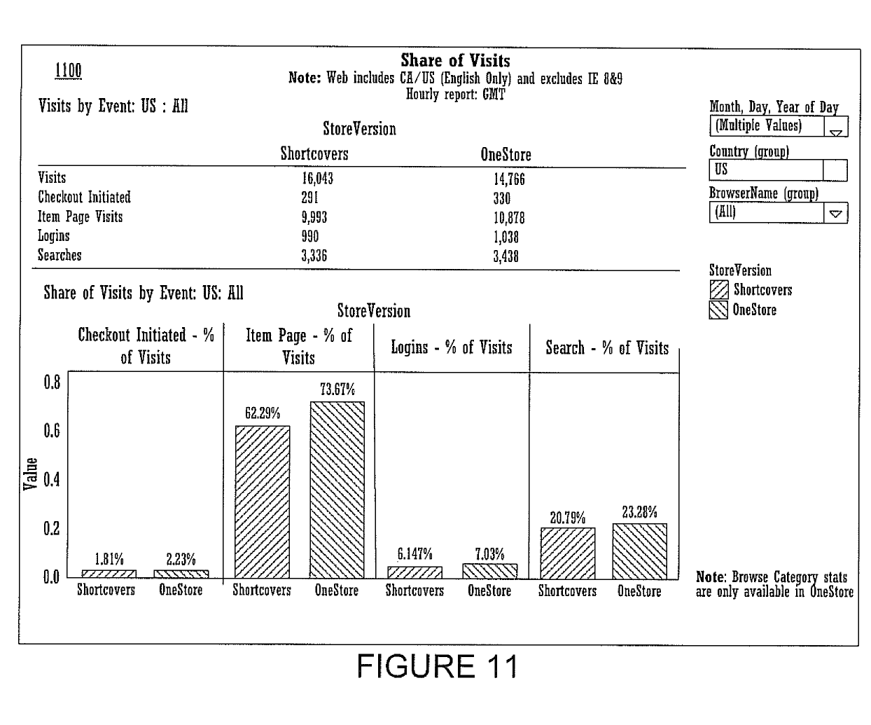

FIG. 11 illustrates an example of a display 1100 showing the number of visits to a Web site where a particular activity occurs (e.g., search conducted, item page visited, checkout initiated, etc.) in an embodiment according to the present invention. The information included in the display 1100 can help diagnose performance and identify anomalies that may be present in the test results. The information presented in the display 1100 can also be filtered by changing the settings of parameters using drop-down menus or the like included in the display 1100.

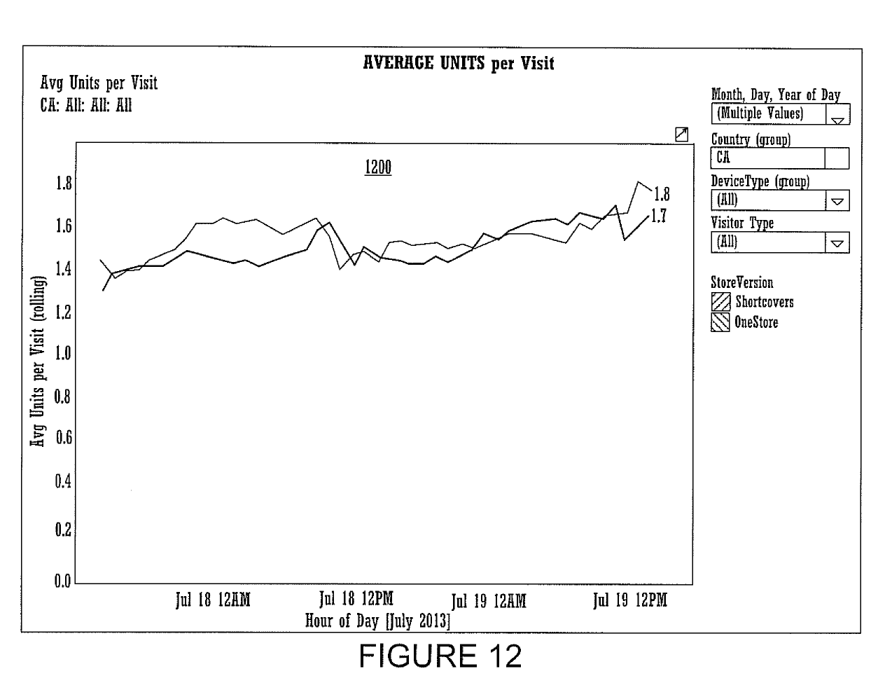

FIG. 12 illustrates an example of a display 1200 showing the average number of units purchased in a visit to a Web site, in an embodiment according to the present invention. The information included in the display 1200 can help diagnose performance by providing context to test results, particularly when used with the other information discussed herein. The information presented in the display 1200 can also be filtered by changing the settings of parameters using drop-down menus or the like included in the display 1200. This embodiment is useful to diagnose if users are buying more or less within a given visit in one variant over the other.

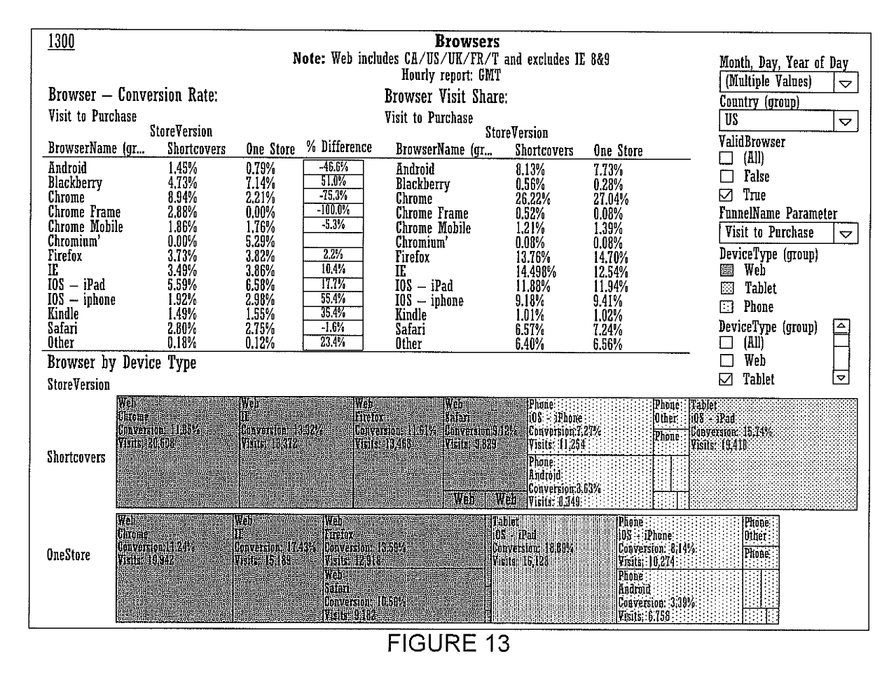

FIG. 13 illustrates an example of a display 1300 showing visits to a Web site and conversions by browser and/or device type, in an embodiment according to the present invention. The information presented in the display 1300 makes it easier to identify the relative performance of different types of browsers and/or devices. The information included in the display 1300 can help diagnose performance by providing context to test results, particularly when used with the other information discussed herein. The information presented in the display 1300 can also be filtered by changing the settings of parameters using drop-down menus or the like included in the display 1300. In the case of AB testing pertaining to Web sites, this embodiment is extremely useful in identifying browsers where features may be broken, as not all browsers are able to accommodate various types of effects. Browser breakdown can be used to identify a browser type that was not rendering correct images and had gone undetected in previous quality assurance work.

FIG. 14 is a flowchart 1400 of an example of a computer-implemented method for presenting test results, in an embodiment according to the present invention. The flowchart 1400 can be implemented as computer-executable instructions residing on some form of computer-readable storage medium (e.g., using the computing system 100 of FIG. 1).

In block 1402 of FIG. 14, a first subset of results from testing a first version of an item versus a second version of the item that is different from the first version is accessed. The first subset includes a first group of values associated with the first version and a second group of values associated with the second version. The first subset is determined (selected or calculated) according to settings for parameters associated with the data.

In block 1404, a display that includes a representation of the first group of values, including a first band having a first width corresponding to confidence intervals for the first group of values, and a representation of the second group of values, including a second band having a second width corresponding to confidence intervals for the second group of values, are rendered.

In block 1406, in response to a change in the settings, a second subset of results are determined automatically according to the change in settings. Also, the first width and the second width of the first and second bands along with the metric presented, respectively, are updated automatically and displayed.

In summary, in embodiments according to the present invention, users can readily determine whether or not the test has been run long enough to accumulate an adequate sample size of test data. Also, test data can be filtered to allow more granular analysis. Test results (metrics) based on the cumulative test data, subsets of the test data, and rolling windows of the test data can be determined, accessed, and displayed. If the data is filtered and the sample size is thus reduced, then the dimensions of the confidence bands are automatically adjusted in response, so that users can readily determine whether or not the filtered data includes enough data for the test results to be statistically valid. Generally speaking, test results can be viewed in different ways while maintaining statistical rigor.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A computer-readable storage medium having stored thereon computer-executable instructions that, when executed, cause a computing system to perform operations comprising:
accessing a first subset of results from testing a first version of an item versus a second version of the item that is different from the first version, the first subset comprising a first plurality of values associated with the first version and a second plurality of values associated with the second version, the first subset selected according to settings for parameters associated with the data;
rendering, in a single view, a display comprising a representation of the first plurality of values including a first band having a first width corresponding to confidence intervals for the first plurality of values and a representation of the second plurality of values including a second band having a second width corresponding to confidence intervals for the second plurality of values; and
in response to a change in the settings, automatically accessing a second subset of the results determined according to the change in settings, and updating the first width and the second width of the first band and the second band in the display.

2. The computer-readable storage medium of claim 1 wherein the display further comprises: a first line within the first band and depicting the first plurality of values versus time, and a second line within the second band and depicting the second plurality of values versus time.

3. The computer-readable storage medium of claim 1 wherein the settings comprise a setting that specifies a rolling window of time.

4. The computer-readable storage medium of claim 1 wherein the item comprises an e-commerce Web site, wherein the settings comprise a setting that specifies a step in a conversion funnel.

5. The computer-readable storage medium of claim 1 wherein the settings are selected from the group consisting of: a geographic location; a language; a type of Web browser; a type of device; and a type of user.

6. The computer-readable storage medium of claim 1 wherein the first plurality of values and the second plurality of values comprise e-commerce conversion rates.

7. The computer-readable storage medium of claim 1 wherein the item comprises an e-commerce Web site, wherein the operations further comprise:
displaying at least some of the results, segmented according to geographic locations;
displaying at least some of the results, segmented according to steps in a conversion funnel;
displaying at least some of the results, segmented according to activities performed by visitors to the Web site;
displaying at least some of the results, segmented according to number of units purchased; and
displaying at least some of the results, segmented according to type of Web browser.

8. A system comprising:
a processor;
a display coupled to the processor; and
memory coupled to the processor, the memory have stored therein instructions that, if executed by the system, cause the system to execute a method comprising:
accessing data from testing a first version of an item versus a second version of the item that is different from the first version;
calculating, from the data, a first plurality of values associated with the first version and a second plurality of values associated with the second version, the first plurality of values and the second plurality of values calculated according to settings for parameters associated with the data;
rendering, on the display, a first representation of the first plurality of values and a second representation of the second plurality of values, the first representation comprising a first band having a first width corresponding to confidence intervals for the first plurality of values, and the second representation comprising a second band having a second width corresponding to confidence intervals for the second plurality of values;
receiving a change to the settings; and
in response to the change, automatically updating the first width and the second width of the first band and the second band in the rendering on the display.

9. The system of claim 8 wherein the first representation comprises a first line within the first band and depicting the first plurality of values versus time, and wherein the second representation comprises a second line within the second band and depicting the second plurality of values versus time.

10. The system of claim 8 wherein the settings comprise a setting that specifies a rolling window of time.

11. The system of claim 8 wherein the item comprises an e-commerce Web site, wherein the settings comprise a setting that specifies a step in a conversion funnel.

12. The system of claim 8 wherein the settings are selected from the group consisting of: a geographic location; a language; a type of Web browser; a type of device; and a type of user.

13. The system of claim 8 wherein the first plurality of values and the second plurality of values comprise e-commerce conversion rates.

14. The system of claim 8 wherein the item comprises an e-commerce Web site, wherein the method further comprises:
displaying test results segmented according to geographic locations;
displaying test results segmented according to steps in a conversion funnel;
displaying test results segmented according to activities performed by visitors to the Web site;
displaying test results segmented according to number of units purchased; and
displaying test results segmented according to type of Web browser.

15. A system comprising:
a processor;
a display coupled to the processor; and
memory coupled to the processor, the memory have stored therein instructions that, if executed by the system, cause the system to execute operations that generate a graphical user interface (GUI) for reporting results of an AB test, the GUI rendered on the display and comprising:
a first representation of a first plurality of values, the first plurality of values associated with a first version of an item being tested with the AB test, the first representation comprising a first band having a first width corresponding to confidence intervals for the first plurality of values, the first representation further comprising a first line within the first band and depicting the first plurality of values versus time;
a second representation of a second plurality of values, the second plurality of values associated with a second version of the item, the second representation comprising a second band having a second width corresponding to confidence intervals for the second plurality of values, the second representation further comprising a second line within the second band and depicting the second plurality of values versus time; and
GUI elements representing a plurality of parameters associated with the results, wherein the first plurality of values and the second plurality of values comprise a first subset of the results determined according to settings for the parameters, wherein in response to a change in the settings a second subset of the results is determined and displayed and the first width and the second width are automatically updated and displayed.

16. The system of claim 15 wherein the settings comprise a setting that specifies a rolling window of time.

17. The system of claim 15 wherein the item comprises an e-commerce Web site, wherein the settings comprise a setting that specifies a step in a conversion funnel.

18. The system of claim 15 wherein the settings are selected from the group consisting of: a geographic location; a language; a type of Web browser; a type of device; and a type of user.

19. The system of claim 15 wherein the first plurality of values and the second plurality of values comprise e-commerce conversion rates.

20. The system of claim 15 wherein the item comprises an e-commerce Web site, wherein the GUI further comprises:
a representation of at least some of the results, segmented according to geographic locations;
a representation of at least some of the results, segmented according to steps in a conversion funnel;
a representation of at least some of the results, segmented according to activities performed by visitors to the Web site;
a representation of at least some of the results, segmented according to number of units purchased; and
a representation of at least some of the results, segmented according to type of Web browser.
